(19) United States
(12) Patent Application Publication
(10) Pub. No.: US 2007/0264930 A1
(43) Pub. Date: Nov. 15, 2007

(54) Telecommunication System and Method for Operating a Mobile Telephone on Board An Aircraft or Ship, Land Station and Base Station Adapted for Said System

(75) Inventor: Jean-Pierre Daoudal, Levis Saint Nom (FR)

Correspondence Address: YOUNG & THOMPSON, 745 SOUTH 23RD STREET, 2ND FLOOR, ARLINGTON, VA, 22202, US

(73) Assignee: ORANGEFRANCE, Montrouge (FR)

(21) Appl. No.: 11/791,824

(22) PCT Filed: Dec. 5, 2005
(86) PCT No.: PCT/FR05/03028

§ 371 Date: Jul. 5, 2007

(30) Foreign Application Priority Data
Dec. 3, 2004 (FR) 04 12888

(51) Int. Cl. H04H 1/00

(52) U.S. Cl. 455/3.02; 455/431

(57) ABSTRACT

A telecommunication system for operating a mobile telephone on board an aircraft or ship includes at least one base station (10) on board the ship or aircraft, and a connection module (34) for switching the connection of the onboard base station from a first to a second public land mobile network (PLMN) in response to a network change command.

The present invention relates to a telecommunication system and method, a land station and a base station adapted for this system.

Known telecommunication systems comprise a base station on board a ship and specifically for creating a local coverage area for the mobile telephones of the ship's passengers.

In these systems, the onboard base station is connected only to the network A of the public land mobile network of an operator of a country X. Consequently, the overall coverage area of the network A consists of a land coverage area in the country X and a maritime coverage area which is more or less limited to the environment of the onboard base station. Such systems pose no problems as long as the ship remains in the territorial waters of the country X.

However, when the ship enters into the territorial waters of a third-party country Y, the onboard base station in the ship creates a coverage area which extends into the territorial waters of the country Y. Such an extension of the coverage area of the network A into the territorial waters of the country Y is prohibited by international regulations.

Thus, in theory, when a ship equipped with an onboard base station enters into the territorial waters of a third-party country, the onboard base station needs to be switched off so that the passengers can no longer make telephone calls until the ship has entered into the coverage area of a public land mobile network B of an operator of the country Y.

There is a similar drawback on board aircraft in international flights.

The invention seeks to remedy this drawback by proposing a telecommunication system that makes it possible to operate a mobile telephone onboard a ship or an aircraft while respecting the national regulations.

The subject of the invention is therefore a telecommunication system comprising:
a connection module specifically for switching the connection of the onboard base station from a first to a second public land mobile network (PLMN) in response to a network change command.

In the above system, the onboard base station can be connected equally to the network A and to the network B. Thus, it becomes possible to avoid extending the coverage area of the network A into the territorial waters or the national airspace of the country Y, since it is enough, after crossing a border of the country Y, to connect the onboard base station to the network B. Consequently, immediately the border has been crossed, the ship's or aircraft's passengers can use their mobile telephones to make calls without waiting for the ship or the aircraft to enter into the land coverage area of the network B.

The embodiments of this system can comprise one or more of the following characteristics:
a sensor specifically for measuring the geographic position of the onboard base station, and a selection module specifically for automatically generating a network change command transmitted to the connection module according to the measured geographic position,
the selection module is adapted to select the network to which the onboard base station must be connected by applying a predetermined rule whereby, if the base station is in the territorial waters or the airspace of a country, it must only be connected to a mobile telephone network of that country,
the predetermined rule defines a buffer area either side of a maritime or air boundary in which the connection of the onboard base station remains unchanged after the first connection switchover, even if the boundary is crossed,
a submodule for downloading a new configuration to the onboard base station to adapt this base station to its connection to a new network.

The embodiments of this system also have the following advantages:
the selection module makes it possible to automatically initiate the connection of the onboard base station to a new mobile network on crossing a boundary,
the use of a predetermined rule as defined above makes it possible to respect the international regulations,
the use of a buffer area makes it possible for a ship or an aircraft to navigate along a boundary without the telephone calls being cut off each time this boundary is crossed.

Another subject of the invention is a land station specially adapted to be used in the above telecommunication system, and a method of operating this telecommunication system.

The invention will be better understood from reading the description that follows, given solely by way of example and with reference to the drawings in which:

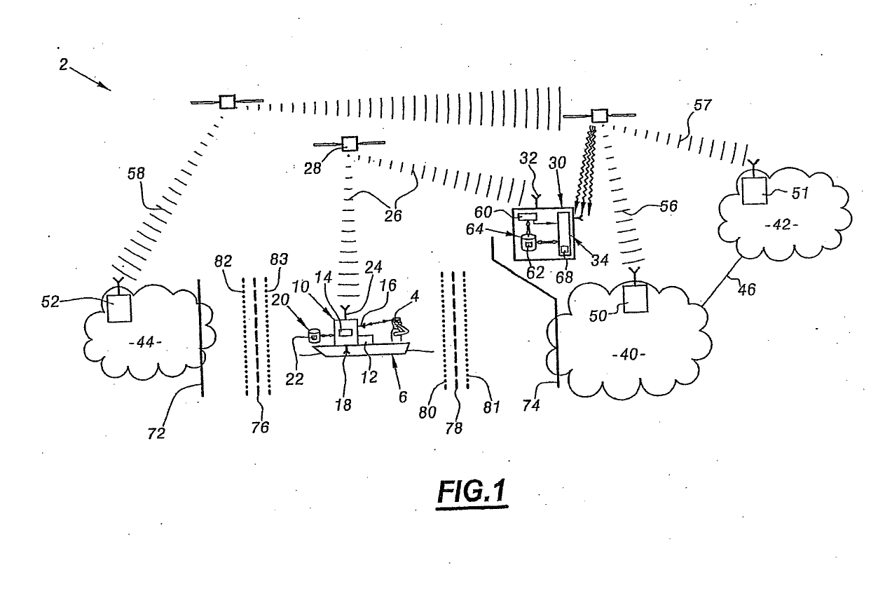

FIG. 1 is a diagrammatic illustration of the architecture of a telecommunication system to handle the operation of a mobile telephone on board a ship, and

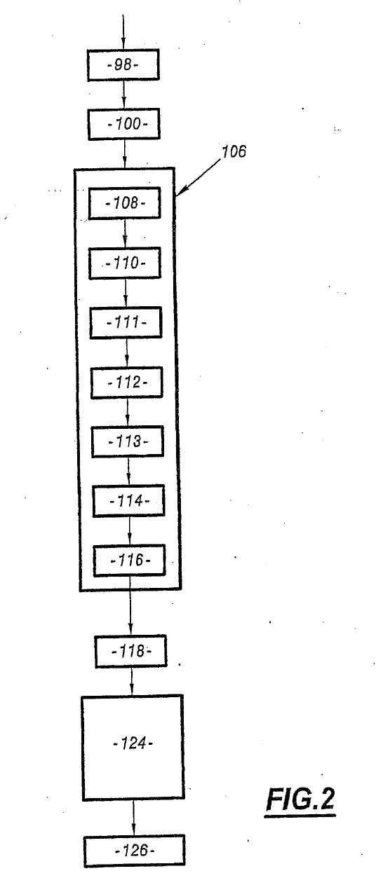

FIG. 2 is a flow diagram of a telecommunication method for handling the operation of a mobile telephone on board a ship.

The terminology used in this description is as defined in particular in the GSM (Global System for Mobile Communication) standards.

FIG. 1 represents a telecommunication system, designated by the general reference 2, specifically for operating a mobile telephone 4 on board a ship 6.

The ship 6 is equipped with a base transceiver station, or BTS, 10 and a sensor 12 specifically for measuring the geographic position of the ship on the Earth's surface.

The sensor 12 is, for example, a GPS (Global Positioning System) sensor.

The station 10 is equipped with at least one transmitter/receiver 14, an outdoor antenna 16 and at least one indoor antenna 18.

The outdoor antenna enables a passenger on the deck of the ship 6 to make a telephone call whereas the indoor antenna 18 enables a passenger located inside the hull of the ship 6 to make a telephone call.

The station 10 is remotely configurable. To this end, it is connected to a memory 20 containing configuration parameters 22 for the station 10. To simplify FIG. 1, the memory 10 is shown external to the station 10 but, preferably, the memory 20 is incorporated in the station 10.

The station 10 is also equipped with an antenna 24 for setting up a satellite link 26 with a land station 30 via a satellite 28.

The land station 30 is equipped with a satellite antenna 32 and a connection module 34 specifically for connecting the station 10 to a BSC (Base Station Controller) of a Public Land Mobile Network (PLMN).

As an illustration, only three PLMN networks 40, 42 and 44 are represented. The networks 40 and 44 are public land mobile networks respectively of the countries Y and X. The network 42 used here when navigating in international waters is a public land mobile network dedicated to international waters, for example. The network 40 is an HPLMN (Home Public Land Mobile Network) for the telephone 4.

Each of these networks 40 and 44 comprises a multitude of land base stations defining an overall land coverage area represented by the cloud-shaped outlines. The networks 40 and 44 also comprise a few base stations on board ships and defining a maritime coverage area. The network 42 is, for example here, made up only of base stations on board ships, which makes it possible to associate a particular billing with this network. Within the overall land coverage area of one of these networks 40 or 44, a mobile telephone can roam without the call being cut off thanks to a function known as “handover”. When a mobile telephone roams from the overall coverage area of one network, for example the network 40, to the overall coverage area of another network, the current telephone call is interrupted on crossing the boundary between these two networks and must be reestablished by making a new call from the new network. This function is known as “roaming”. To this end, typically, the various networks are connected via information transmission links such as, for example, the link 46 which links the network 40 to the network 42.

Each of these networks 40, 42 and 44 comprises a BSC station specifically adapted for connection to the station 10. Here, three of these BSC stations 50 to 52 respectively belonging to the networks 40, 42 and 44 are represented.

The connection module 34 is more specifically suitable for connecting the station 10 to the BSC stations 50 to 52 via respective satellite links 56, 57 and 58.

The module 34 connects the station 10 exclusively to one single BSC station at a time. The switchover of the connection of the station 10 to a new network occurs in response to a network change command.

Here, in order to respect international regulations, the land station 30 comprises a selection module 60 specifically for automatically generating a network change command and for transmitting it to the connection module according to the geographic position measured by the sensor 12. More specifically, the selection module 60 acts in accordance with rules 62 pre-stored in a memory 64. Examples of pre-stored rules are given in light of FIG. 2.

For example, the memory 64 contains the following rules:
if the ship 6 navigates in the territorial waters of a country, then the station 10 must be connected to the public land mobile network of that country,
if the ship 6 navigates in international waters, then the station 10 must be connected to the network 42, and
if the ship 6 navigates in a buffer area either side of a maritime boundary, then:

a) on first crossing the boundary, the station 10 must be connected to the public land mobile network of the country into whose territorial waters the ship has just entered or to the network 42 if they are international waters, and

b) after this first crossing of the boundary and until the ship has left the buffer area, keeping the connection of the station 10 set up in the point a) unchanged.

To determine whether the ship 6 is in the territorial waters of a country or in international waters, or even in a buffer area, the module 6 is also able to compare the geographic position measured for the ship 6 with a pre-stored maritime map on which are defined the maritime boundaries between territorial waters and international waters, and the buffer areas.

The connection module 34 is equipped with a submodule 68 for downloading a new configuration to the station 10. To this end, configuration parameters to be downloaded are stored, for example, in the memory 64. Typically, these configuration parameters are supplied by the operators of the networks 40, 42 and 44 of the system 2.

Finally, the bold lines 72 and 74 represent the coasts respectively of the country X and of the country Y. The dashed lines 76, 78 represent the maritime boundaries respectively of the countries X and Y between on the one side their territorial waters and on the other the international waters.

Dotted lines 80 to 83 which extend parallel to the maritime boundaries 76, 78 and either side of each of these boundaries, define a buffer area, the benefit of which will become apparent from reading the method described in light of FIG. 2. Typically, each buffer area corresponds to a strip 2 to 10 km wide which extends either side of the maritime boundary. The width of the buffer area is parameterizable.

The operation of the system 2 will now be described with the help of FIG. 2 in the particular case of the ship 6 when sailing from the country Y to the country X.

In a step 98, when the system 2 is activated, the sensor 12 measures the geographic position of the ship and transmits it to the land station 30 which acquires this measurement.

Initially, the ship 6 is docked in a port of the country Y. In this state, the station 10 is connected to the network 40 via satellite links 26 and 56. In these conditions, when a passenger makes a telephone call from the telephone 4, said call is handled as a national call since the telephone 4 is in its HPLMN network.

When the ship moves away from the coast 74 to approach the line 81, the connection module 34, in a step 100, maintains the connection of the station 10 to the network 40. Consequently, in the territorial waters of the country Y, any call made from the telephone 4 is considered as a national call and billed as such.

Then, when the ship 6 crosses the line 81 and enters into the buffer area, the module 34 maintains the connection of the station 10 to the network 40 according to the pre-stored rules 62.

If the ship 6 continues to move away from the coast 74, it crosses the boundary 78 for the first time. At this moment, the land station 30 records the crossing of the boundary 78 and proceeds with a step 106 to switch the connection of the station 10 from the network 40 to the network 42.

To this end, in an operation 108, the station 10 is switched off, that is, its coverage area is eliminated. This is, for example, done by gradually reducing the power of the transmitter/receiver 14 to gradually reduce the coverage area until it disappears completely.

Then, in an operation 110, the connection module 34 disconnects the station 10 from the network 40 and, more specifically, from the BSC station 50. To this end, the satellite link 56 is interrupted. In this operation 110, the land station 30 acts on the network 40 so that the latter does not trigger an alarm in response to the disconnection of the station 10. Conventional means are used for this such as, for example, the looping of the link 56 or the sending of specific instructions to the BSC station 50.

Once the station 10 is disconnected from the network 40, the module 60, in an operation 111, selects another network to which the station 10 must be connected according to the current geographic position measured by the sensor 12 and pre-stored rules 62. For example, here, the pre-stored rules indicate that the station 10 must be connected to the network 42.

Once the network to which the station 10 must be connected has been selected, the selection module 60, in an operation 112, sends a network change command to the connection module 34. In response, in an operation 113, the module 34 and, more specifically, the submodule 68, downloads the configuration parameters of the station 10, necessary for its connection to the selected new network, into the memory 20 via the satellite link 26.

Once the station 10 has been configured to be connected to the network 42 and, more specifically, to the BSC station 51, the module 34, in an operation 114, connects the station 10 to the network 42 via the satellite link 57. Once the connection is completed, in an operation 116, the station 10 is switched on so as to create a coverage area which encompasses the ship 6. Typically, in the operation 116, the coverage area is created by gradually increasing the power of the transmitter/receiver 14 until a coverage area is obtained that makes it possible to make a call from any point of the ship 6.

In the step 106, the “roaming” function is implemented so that calls in progress are interrupted and must be re-established once the station 10 is connected to the network 42.

Then, as long as the ship 6 navigates in the buffer area, the connection module, in a step 118, maintains the connection of the station 10 to the network 40 even if the ship once again crosses the boundary 78. This limits the number of network changes when a ship navigates along and close to the boundary 78.

In international waters, any call made from the telephone 4 is considered as an international call passing through the network 42, and will therefore be billed at a specific rate.

When the ship 6 crosses the line 83 and enters into the buffer area around the boundary 76, the module 34 maintains the connection of the station 10 to the network 42 as long as the boundary 76 has not been crossed for the first time.

When the ship 6 nears the coast 72 and crosses the boundary 76, then a new switchover of the connection of the station 10 from the network 42 to the network 44 must be performed in a step 124. This step 124 is performed in the same way as the step 106, apart from the fact that:
the references of the links 56 and 57 are respectively replaced by the references 57 and 58
the references of the networks 40 and 42 are respectively replaced by the references 42 and 44, and
the references of the BSC stations 50 and 51 are respectively replaced by the references 51 and 52.

Thus, at the end of the step 124, the station 10 is connected to the network 44 via the satellite link 58. In these conditions, any call made from the mobile telephone 4 is billed as an international call since the network 44 is not the HPLMN network of the telephone 4.

Then, as long as the ship 6 navigates within the buffer area, the connection of the station 10 to the network 44 is maintained unchanged, in a step 126.

With the system 2, as long as the ship 6 is in the territorial waters of the country X or Y, the station 10 is connected to the network of an operator of that country X or Y, such that international regulations are respected.

In international waters, the station 10 is connected to the network 42 of an operator of a country Z, which is also compliant with the international regulations.

Thus, with the system 2, it is possible both to operate a mobile telephone on board a ship crossing maritime boundaries and to respect the international regulations and billing rules.

Numerous other embodiments of this system are possible. For example, the downloading module 34 is, as a variant, implemented in the BSC stations of the public land mobile networks to which the station 10 must be connected. This variant enables the operator of the national network to have direct access to the configuration parameters that he wants to download to the station 10.

The system 2 has been described in the particular case where the geographic position is measured using a sensor 12 on board the ship 6. However, this geographic position of the ship 6 can be acquired and transmitted by any means to the land station 30. For example, the position of the ship 6 is determined by radars positioned on the coasts.

Here, the change of network is initiated automatically by the selection module according to the measured geographic position of the ship. As a variant, this change of network is initiated manually by an operator on board the ship 6.

The links 56 to 58 have been described as being satellite links. As a variant, these links are replaced by links using other transmission media such as, for example, optical fibers.

What has just been described in the particular case of a ship also applies to an aircraft containing a base station such as the station 10.

1. A telecommunication system for operating a mobile telephone onboard a ship or an aircraft, characterized in that the system comprises:
at least one configurable base station (10) onboard the ship or aircraft and specifically for creating a local coverage area for the mobile telephones of the passengers of the ship or of the aircraft, this base station being connected to a first BSC (Base Station Controller) station of a first Public Land Mobile Network (PLMN), and configured so that any call made from a mobile telephone within the coverage area of the onboard base station is treated as a national call if the first network is the HPLMN network (Home Public Land Mobile Network) of this mobile telephone, and
a connection module (34) specifically for switching the connection of the onboard base station from the first BSC station to a second BSC station of a second public land mobile network in response to a network change command, and for configuring the base station so that this time any call made from the same mobile telephone within the coverage area of the onboard base station will be considered as an international call passing through the second network if the first network is this mobile telephone's HPLMN network.

2. The system as claimed in claim 1, characterized in that it comprises:
a sensor (12) specifically for measuring the geographic position of the onboard base station, and
a selection module (60) specifically for automatically generating a network change command transmitted to the connection module according to the measured geographic position.

3. The system as claimed in claim 2, characterized in that the selection module (60) is adapted to select the network to which the onboard base station must be connected by applying a predetermined rule (62) whereby, if the base station is in the territorial waters or the airspace of a country, it must only be connected to a mobile network of that country.

4. The system as claimed in claim 3, characterized in that the predetermined rule (62) defines a buffer area either side of a maritime (76, 78) or air boundary in which the connection of the onboard base station remains unchanged after a first connection switchover, even if the boundary is crossed.

5. The system as claimed in claim 1, characterized in that it comprises a submodule (68) for downloading a new configuration to the onboard base station to adapt this base station to its connection to a new network.

6. A land station adapted to be used in a telecommunication system as claimed in claim 1, characterized in that it comprises the connection module (34) specifically for switching the connection of the onboard base station from the first BSC station to a second BSC station of a second public land mobile network (PLMN) in response to a network change command.

7. The land station as claimed in claim 6, characterized in that it comprises the selection module (60) specifically for automatically generating a network change command transmitted to the connection module according to the measured geographic position of the onboard base station.

8. An onboard base station on board a ship or an aircraft suitable for use in a telecommunication system as claimed in claim 5, characterized in that it comprises configuration parameters (22) suitable to be modified by the module for downloading a new configuration.

9. A telecommunication method for operating a mobile telephone on board a ship or an aircraft comprising an onboard configurable base station specifically for creating a local coverage area for the mobile telephones of the passengers of this ship or this aircraft, this base station being connected to a first BSC (Base Station Controller) station of a first Public Land Mobile Network (PLMN) and configured so that any call made from a mobile telephone within the coverage area of the onboard base station is treated like a national call if the first network is the HPLMN network (Home Public Land Mobile Network) of this mobile telephone, characterized in that it comprises a step (106, 124) for switching the connection of the onboard base station from the first BSC station to a second BSC station of a second public land mobile network (PLMN) in response to a network change command and a step for configuring the base station so that this time any call made from the mobile telephone within the coverage area of the onboard base station will be considered as an international call passing through the second network if the first network is the HPLMN of this mobile telephone.

10. The method as claimed in claim 9, characterized in that it comprises a step (98) for measuring the geographic position of the onboard base station and a step (112) for automatically generating a network change command according to the measured geographic position.

11. The system as claimed in claim 2, characterized in that it comprises a submodule (68) for downloading a new configuration to the onboard base station to adapt this base station to its connection to a new network.

12. The system as claimed in claim 3, characterized in that it comprises a submodule (68) for downloading a new configuration to the onboard base station to adapt this base station to its connection to a new network.

13. The system as claimed in claim 4, characterized in that it comprises a submodule (68) for downloading a new configuration to the onboard base station to adapt this base station to its connection to a new network.

14. A land station adapted to be used in a telecommunication system as claimed in claim 2, characterized in that it comprises the connection module (34) specifically for switching the connection of the onboard base station from the first BSC station to a second BSC station of a second public land mobile network (PLMN) in response to a network change command.

15. A land station adapted to be used in a telecommunication system as claimed in claim 3, characterized in that it comprises the connection module (34) specifically for switching the connection of the onboard base station from the first BSC station to a second BSC station of a second public land mobile network (PLMN) in response to a network change command.

16. A land station adapted to be used in a telecommunication system as claimed in claim 4, characterized in that it comprises the connection module (34) specifically for switching the connection of the onboard base station from the first BSC station to a second BSC station of a second public land mobile network (PLMN) in response to a network change command.

17. A land station adapted to be used in a telecommunication system as claimed in claim 5, characterized in that it comprises the connection module (34) specifically for switching the connection of the onboard base station from the first BSC station to a second BSC station of a second public land mobile network (PLMN) in response to a network change command.
